(19) United States
(12) Patent Application Publication
(10) Pub. No.: US 2025/0028861 A1
(43) Pub. Date: Jan. 23, 2025

(54) EFFICIENT VIDEO ENCRYPTION METHOD AND APPARATUS

(71) Applicant: INDUSTRY ACADEMY COOPERATION FOUNDATION OF SEJONG UNIVERSITY, Seoul (KR)

(72) Inventors: Young Gab KIM, Seoul (KR); Deok Han KIM, Seoul (KR)

(21) Appl. No.: 18/776,392

(22) Filed: Jul. 18, 2024

(30) Foreign Application Priority Data
Jul. 18, 2023 (KR) 10-2023-0092871

(51) Int. Cl. G06F 21/62; H04N 19/119; H04N 19/167; H04N 19/70; H04N 19/91

(52) U.S. Cl. CPC G06F 21/6254; H04N 19/119; H04N 19/167; H04N 19/70; H04N 19/91

(57) ABSTRACT

Disclosed are a video encryption method and device capable of reducing the time required for encrypting a region of interest. The disclosed video encryption method includes selecting one or more target frames to be encrypted from among frames of a target video, detecting regions of interest in the target frame, and performing encryption on the regions of interest.

### CROSS-REFERENCE TO RELATED APPLICATIONS

This application claims priority under 35 U.S.C. § 119 (a) to Korean Patent Application No. 10-2023-0092871, filed on Jul. 18, 2023, with the Korean Intellectual Property Office, the disclosure of which is incorporated herein in its entirety by reference.

### FIELD OF THE INVENTION

The present disclosure relates to a video encryption method and device, and more specifically, to a method and device for efficiently encrypting a region of interest of a video.

### BACKGROUND ART

As closed-circuit television (CCTV) increases in real life, concerns about the leakage of personal information in videos are also increasing. Since various pieces of personal information can be exposed in videos recorded by CCTV, video encryption technology that can de-identify personal information is required. Currently, High Efficiency Video Coding (HEVC) is widely used for efficiency in various video recording devices, and real-time region-of-interest encryption technology that encrypts only regions of interest of videos is being studied for efficient encryption in HEVC videos.

In the region-of-interest encryption technology, encryption is performed only on a region of interest, which is not an entire frame but a part of the frame, and thus the encrypted region is reduced so that the time required for encryption is shortened, and visually better results are obtained. However, an object detection process should be performed for each frame to identify a region of interest, which increases the time required for encryption.

Therefore, a method for encrypting a region of interest more rapidly is required.

### DISCLOSURE

### Technical Problem

The present disclosure is directed to providing a video encryption method and device capable of reducing the time required for encryption.

In particular, the present disclosure is also directed to providing a video encryption method and device capable of reducing the time required for encrypting a region of interest.

### Technical Solution

According to an aspect of the present disclosure to achieve the above objects, there is provided a video encryption method which includes selecting one or more target frames to be encrypted from among frames of a target video, detecting regions of interest in the target frame, and performing encryption on the regions of interest.

According to another aspect of the present disclosure to achieve the above objects, there is provided a video encryption method which includes receiving a target video, selecting some frames from among all frames of the target video as target frames, and encrypting the target frames.

According to still another aspect of the present disclosure to achieve the above objects, there is provided a video encryption device which includes a memory, and at least one processor electrically connected to the memory, wherein the processor selects one or more target frames to be encrypted from among frames of a target video, detects regions of interest in the target frame, and performs encryption on the regions of interest.

### Advantageous Effects

According to an embodiment of the present disclosure, encryption can be performed on regions of interest in all frames of a video without performing detection of the regions of interest in all of the frames of the video, and thus the time required for encrypting the regions of interest can be reduced.

### DESCRIPTION OF DRAWINGS

FIGS. 1A and 1B are views for describing a concept of a video encryption method according to an embodiment of the present disclosure.

FIG. 2 is a flowchart for describing a video encryption method according to an embodiment of the present disclosure.

FIG. 3 is a view of frames for describing a video encryption method according to an embodiment of the present disclosure with frames.

FIG. 4 is a view for describing tiles of a target frame according to an embodiment of the present disclosure.

FIG. 5 is a view for describing a method of selecting a target frame according to an embodiment of the present disclosure.

FIG. 6 is a view for describing the performance of a video encryption method according to an embodiment of the present disclosure.

FIG. 7 is a flowchart for describing a video encryption method according to another embodiment of the present disclosure.

### DETAILED DESCRIPTION OF EXEMPLARY EMBODIMENTS

While the present disclosure is open to various modifications and alternative forms, specific embodiments thereof are shown by way of example in the accompanying drawings and will herein be described in detail. However, it should be understood that there is no intent to limit the present disclosure to the particular forms disclosed, and on the contrary, the present disclosure is to cover all modifications, equivalents, and alternatives falling within the spirit and scope of the present disclosure. Like reference numerals refer to like elements throughout the description of the drawings.

Hereinafter, embodiments of the present disclosure will be described in detail with reference to the accompanying drawings.

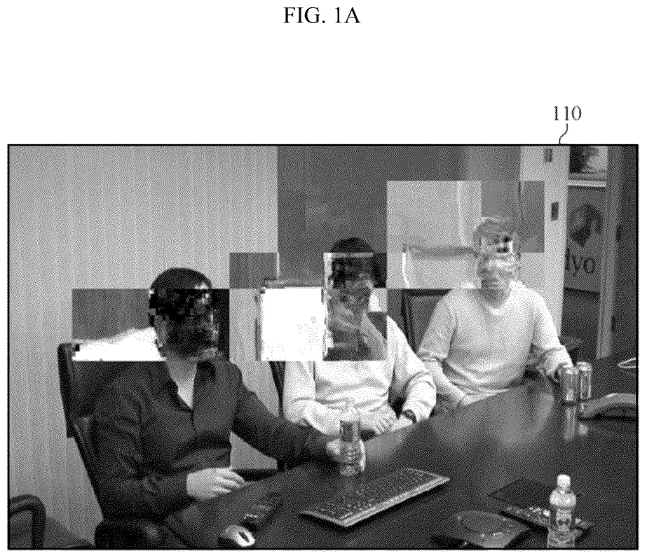

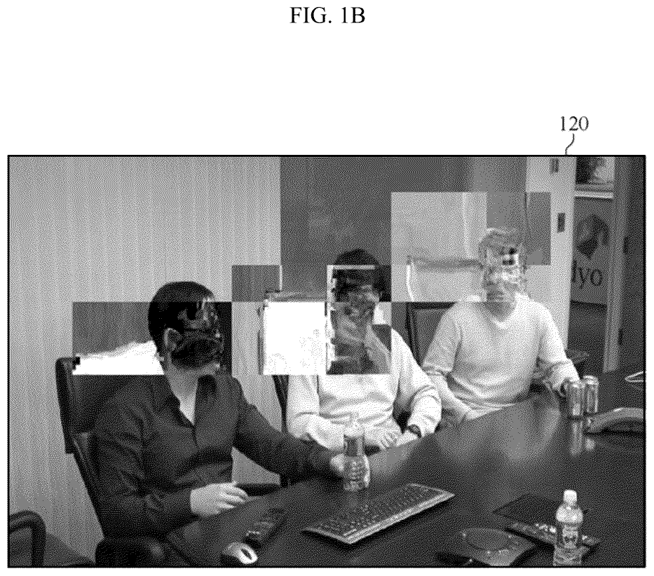

FIGS. 1A and 1B are views for describing a concept of a video encryption method according to an embodiment of the present disclosure.

As described above, in order to perform encryption to prevent exposure of regions of interest in a video, detection of the regions of interest is essential, and when encryption is performed by detecting regions of interest in all frames of the video, the encryption takes a considerable time in proportion to the number of frames.

Accordingly, in the present disclosure, an encryption method and device that can reduce the time required for encryption during a process of encoding a video, by selectively detecting regions of interest in some frames and performing encryption thereon, instead of detecting regions of interest in all frames of the video and performing encryption thereon, are proposed. That is, in the present disclosure, region-of-interest encryption is selectively performed on some frames while encoding the video. The video may be encoded using the High Efficiency Video Coding (HEVC) codec.

In one embodiment of the present disclosure, encryption is selectively performed on frames that have a significant impact on other frames, among frames of a video, while encoding the video. Here, the frames that have a significant impact on other frames are frames with a relatively high frequency of references by other frames. When a frame referencing the frame in which the region of interest has been encrypted is encoded, the corresponding frame is encoded by reflecting the already encrypted region of interest in the corresponding frame, and thus the same effect as when the region of interest is encrypted can be obtained even when the region of interest is not encrypted. Therefore, when encryption is performed on regions of interest in some frames with a high frequency of references, the same effect as when regions of interest in all frames of the video are encrypted can be obtained.

In FIGS. 1A and 1B, a first frame 110 is a frame in which regions of interest are encrypted after the regions of interest are detected, and a second frame 120 is a frame in which encoding is performed by referencing the first frame 110 without performing a separate encryption process. In FIGS. 1A and 1B, the region of interest corresponds to a region in the frame that includes a person's face.

Since encoding is performed on the second frame 120 by referencing the first frame 110, the same effect as when regions of interest in the second frame 120 that references the first frame 110 are also encrypted is obtained when encryption is performed on the regions of interest in the referenced first frame 110 as shown in FIGS. 1A and 1B.

Therefore, as in one embodiment of the present disclosure, when encryption is performed on the regions of interest in the frames with a high frequency of references, an effect in which encryption is performed on the regions of interest in all of the frames of the video without performing detection on the regions of interest in all of the frames of the video can be obtained.

Eventually, according to one embodiment of the present disclosure, since de-identification processing may be performed on the regions of interest in all of the frames of the video without performing detection of the regions of interest in all of the frames of the video, the time required for encrypting the regions of interest can be reduced.

The video encryption method according to an embodiment of the present disclosure may be performed in a computing device including a memory and at least one processor electrically connected to the memory. The processor may perform a series of processes for video encryption according to an embodiment of the present disclosure.

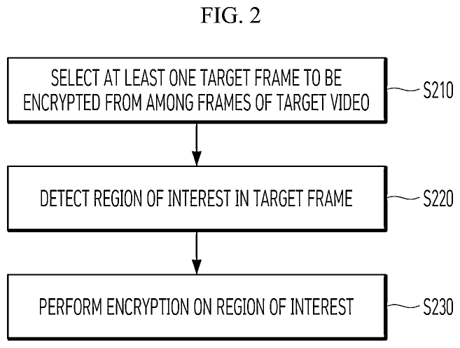

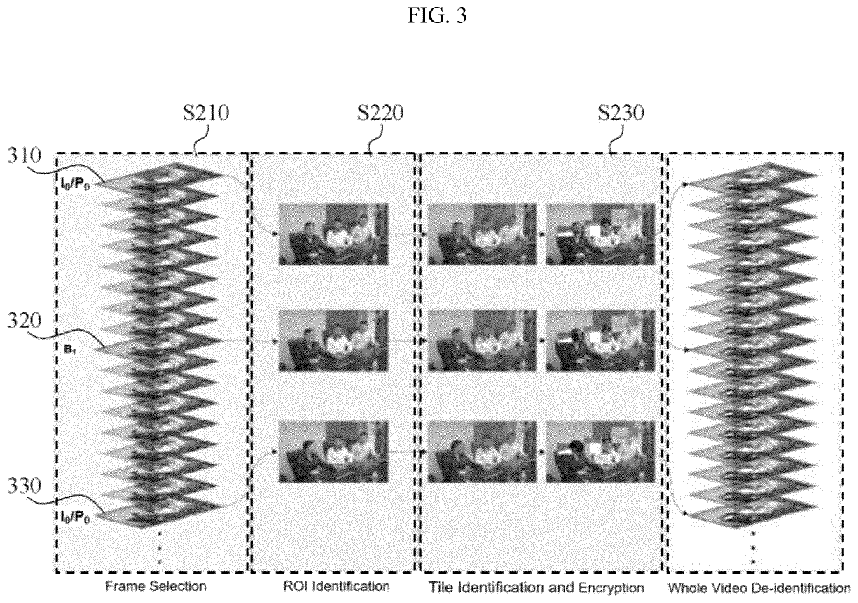

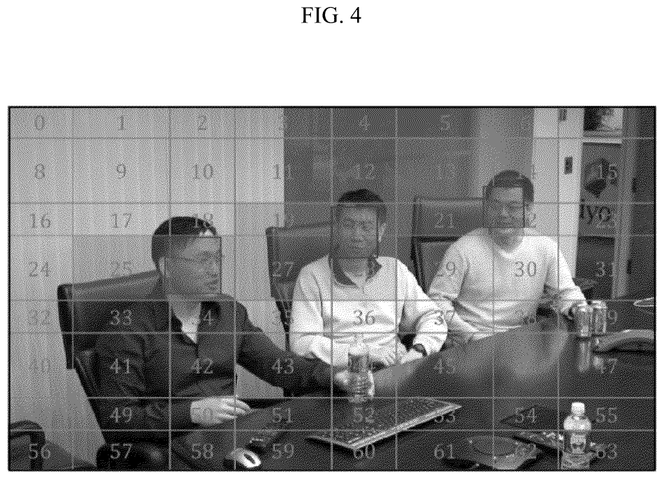

FIG. 2 is a flowchart for describing a video encryption method according to an embodiment of the present disclosure, and FIG. 3 is a view of frames for describing the video encryption method according to the embodiment of the present disclosure with frames. Further, FIG. 4 is a view for describing tiles of a target frame according to the embodiment of the present disclosure.

In FIGS. 2 and 3, an embodiment of the video encryption method performed in a video encryption device, which is an example of the computing device described above, will be described.

Referring to FIGS. 2 and 3, the video encryption device according to an embodiment of the present disclosure selects one or more target frames to be encrypted from among frames of a target video (S210). As shown in FIG. 3, some frames 310, 320, and 330 may be selected from among the frames of the target video as the target frames.

As described above, the video encryption device may select the target frames according to a frequency of references to the frames of the target video, and select frames with a relatively high frequency of references as the target frames. In some embodiments, the frequency of references used to select the target frames may be determined in various ways.

The video encryption device detects regions of interest in the target frames selected in operation S210 (S220). The video encryption device may detect the regions of interest using an object detection algorithm, for example, You Only Look Once v4 (YOLOv4). In FIG. 3, the target frames 310, 320, and 330 in which persons' faces are detected as the regions of interest are shown.

The video encryption device performs encryption on the regions of interest detected in operation S220 (S230). In this case, the video encryption device may perform encryption in units of tiles. In order to perform encoding in parallel in HEVC, the frame is divided into rectangular tiles as shown in FIG. 4 and encoding is performed on the rectangular tiles, and the video encryption device may identify tiles that include all or a part of the regions of interest in the target frame and perform encryption on the identified tiles. The tiles that include all or a part of the regions of interest may be identified through locations of the regions of interest and locations of the tiles.

As shown in FIG. 4, when the target frame is divided into tiles, the video encryption device performs encryption on tiles 25, 26, 19, 20, 27, 28, 13, 14, 21, and 22, which include faces as the regions of interest. The first frame 110 of FIG. 1A is a frame in which regions of interest are encrypted in units of tiles. Regions wider than the regions of interest are encrypted by encrypting the tiles that include all or a part of the regions of interest, and thus exposure of the regions of interest may be prevented even when regions requiring encryption are not detected due to a detection error of the regions of interest.

Meanwhile, the video encoding process may be largely divided into a discrete cosine transform (DCT) stage, a quantization stage, and an entropy encoding stage, and the video encryption device may selectively encrypt some syntax elements among syntax elements generated prior to an entropy encoding stage performed in operation S230, in the entropy encoding stage. Syntax compliance and compression efficiency compliance may be achieved by encrypting some syntax elements rather than all the syntax elements. The video encryption device may encrypt some of the syntax elements for the identified tiles.

The entropy encoding stage may be largely divided into a binarization stage, a syntactic modeling stage, and an arithmetic encoding stage, and the video encryption device may selectively encrypt only some syntax elements that have a significant impact on visual results, such as an intra prediction mode (IPM), a quantized transform coefficient (QTC), QTC signs, a motion vector difference (MVD), and MVD signs, after the binarization of the syntax elements is performed. The encryption may be performed using an encryption algorithm such as the advanced encryption standard (AES)-the cipher feedback (CFB) mode, or the like.

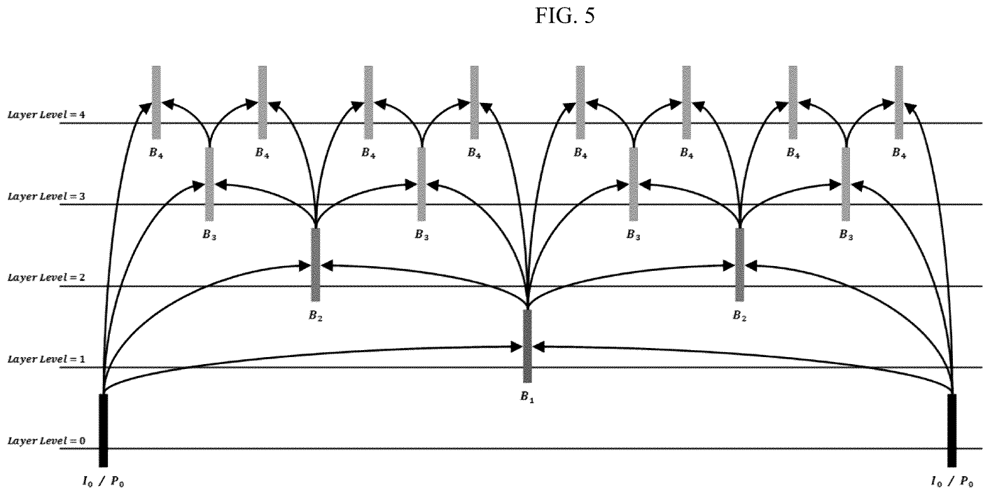

FIG. 5 is a view for describing a method of selecting a target frame according to an embodiment of the present disclosure.

In HEVC, which is one current video standard codec, frames of a video are divided into I-frames, B-frames, and P-frames, and encoding is performed by referencing a previous frame or previous and next frames depending on an encoding mode. The encoding mode includes an all-Intra mode in which encoding is performed without referencing other frames, a low delay mode in which encoding is performed by referencing a previous frame, and a random access mode in which encoding is performed by referencing both previous and next frames.

Further, in the random access mode, as shown in FIG. 5, a hierarchical B-frame structure is used. A frequency of references varies depending on layers of B-frames, and the lower the layer, the higher the frequency of references of the B-frame. A frequency of references of a B-frame of the highest layer (Layer Level=4) is the lowest, and a frequency of references of a B-frame of the lowest layer (Layer Level=1) among the layers of the B-frames is the highest.

The video encryption device according to an embodiment of the present disclosure may select an I-frame, a P-frame, and a B-frame of at least one layer that is lower than a B-frame of the highest layer as target frames to be encrypted. In some embodiments, a B-frame of at least one level among B-frames between Level 1 (Layer Level=1) and Level 3 (Layer Level=3) may be selected as the target frame.

Meanwhile, as one embodiment, a layer of the B-frame selected as the target frame may be adaptively determined according to resource usage of the video encryption device. As the resource usage increases, a distance between the layer of the B-frame selected as the target frame and the highest layer of the B-frame may increase. That is, as an amount of resources used by the video encryption device increases, an amount of available resources decreases, and thus the B-frame of the lower layer may be selected as the target frame in order to reduce a load of the video encryption device.

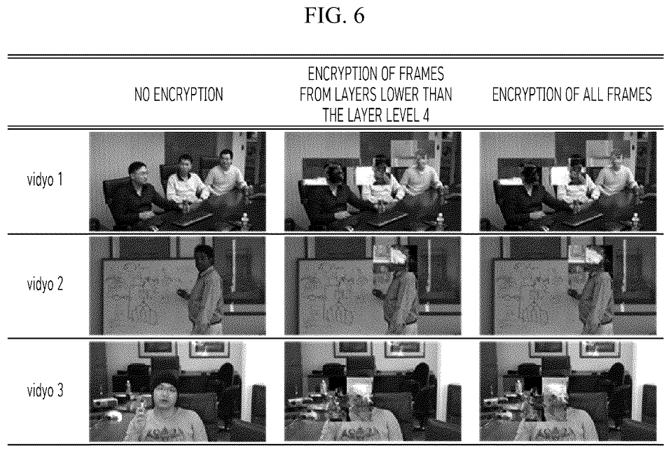

FIG. 6 is a view for describing the performance of a video encryption method according to an embodiment of the present disclosure.

In order to measure encryption performance improvement according to an embodiment of the present disclosure, an experiment was conducted using “Kvazaar,” which is an open source HEVC/H.265 encoder. In addition, as a dataset for the experiment, three videos, “vidyo1,” “vidyo2,” and “vidyo3” from Derf's Collection provided by Xiph.org, were used.

Table 1 shows average times (unit: ms) taken to identify regions of interest per frame, and Table 2 shows average times (unit: ms) taken to encrypt the regions of interest per frame. In addition, Table 3 shows peak signal-to-noise ratios (PSNR) of de-identified tiles without separate encryption processing, and Table 4 shows structural similarity index measure (SSIM) of the de-identified tiles without separate encryption processing.

In Tables 1 to 4, the expression “Level≤1” indicates that region-of-interest encryption was performed on a B-frame of the lowest layer (Layer Level=1), an I-frame, and a P-frame, and the expression “Level≤2” indicates that region-of-interest encryption was performed on B-frames of Level 2 (Layer Level=2) and Level 1 (Layer Level=1), the I-frame, and the P-frame. In addition, the expression “Level≤3” indicates that region-of-interest encryption was performed on B-frames of Level 3 (Layer Level=3), Level 2, and Level 1, the I-frame, and the P-frame, and the expression “Level≤4” indicates that region-of-interest encryption was performed on B-frames of all the layers, the I-frame, and the P-frame.

TABLE 1

Encrypted layers

| | | | | Level ≤ 4 |
|---|---|---|---|---|
| | Level ≤ 1 | Level ≤ 2 | Level ≤ 3 | (all layers) |
| vidyo 1 | 1.608 | 2.934 | 5.816 | 11.614 |
| vidyo 2 | 1.606 | 2.928 | 5.817 | 11.625 |
| vidyo 3 | 1.605 | 2.931 | 5.805 | 11.610 |

TABLE 2

Encrypted layers

| | | | | Level ≤ 4 |
|---|---|---|---|---|
| | Level ≤ 1 | Level ≤ 2 | Level ≤ 3 | (all layers) |
| vidyo 1 | 7.317 | 9.455 | 11.460 | 12.808 |
| vidyo 2 | 2.413 | 3.298 | 4.590 | 5.170 |
| vidyo 3 | 4.838 | 6.627 | 8.915 | 10.732 |

TABLE 3

Encrypted layers

| | | | | Level ≤ 4 |
|---|---|---|---|---|
| | Level ≤ 1 | Level ≤ 2 | Level ≤ 3 | (all layers) |
| vidyo 1 | 7.224 | 6.473 | 6.482 | 6.432 |
| vidyo 2 | 6.560 | 6.565 | 6.538 | 6.571 |
| vidyo 3 | 6.726 | 6.810 | 6.878 | 6.864 |

TABLE 4

Encrypted layers

| | | | | Level ≤ 4 |
|---|---|---|---|---|
| | Level ≤ 1 | Level ≤ 2 | Level ≤ 3 | (all layers) |
| vidyo 1 | 0.180 | 0.060 | 0.047 | 0.030 |
| vidyo 2 | −0.192 | −0.195 | −0.198 | −0.197 |
| vidyo 3 | 0.304 | 0.311 | 0.320 | 0.315 |

Tables 1 and 2 show results of measuring times taken to identify and encrypt regions of interest in some frames selected according to the layer levels during video encoding. The results show that, as compared with when encrypting regions of interest in all of the frames, a time taken to identify regions of interest in some frames from layers lower than the layer level 4 was reduced by about 86% on average, and a time taken to encrypt regions of interest was reduced by about 50% on average.

Tables 3 and 4 show the PSNR and SSIM of tiles de-identified without separate encryption processing. Here, the tiles de-identified without separate encryption processing are tiles in which regions of interest are encrypted by referencing other frames without performing an encryption process. The PSNR and SSIM are indicators with which differences from an original image can be compared, and the closer both the PSNR and SSIM are to 0, the greater the difference from the original image. It can be seen that there is no large difference between the PSNR and SSIM when encrypting frames from layers lower than the layer level 4 and the PSNR and SSIM when encrypting all layers, which means that even when the frames from layers lower than the layer level 4 are encrypted, frames that are not subject to encryption are also sufficiently encrypted.

FIG. 6 is a comparison view between de-identified frames, on which encryption is not performed, and unencrypted frames in a video encrypted according to layer levels. It can be seen that, when a video in which frames of all layers are encrypted is compared with a video in which only selected frames from layers lower than the layer level 4 are encrypted, there is no significant visual difference therebetween.

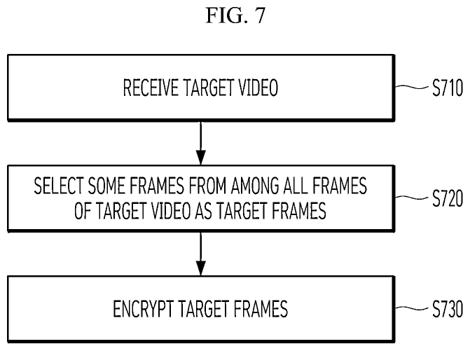

FIG. 7 is a flowchart for describing a video encryption method according to another embodiment of the present disclosure.

Referring to FIG. 7, the video encryption device according to an embodiment of the present disclosure receives a target video (S710), selects some frames from among all frames of the received target video as target frames (S720), and encrypts the selected target frames (S730). The video encryption device may perform encryption on the selected target frames without detecting a region of interest.

In operation S720, as in the above-described embodiment, the video encryption device may select the target frames according to a frequency of references to the frames of the target video, and may select an I-frame, a P-frame, and a B-frame of at least one layer that is lower than a B-frame of the highest layer as the target frames.

The technical content described above may be implemented in the form of program instructions that can be executed through various computer units and recorded on computer readable media. The computer readable media may include program instructions, data files, data structures, or a combination thereof. The program instructions recorded on the computer readable media may be specially designed and prepared for embodiments of the disclosure or may be available well-known instructions for those skilled in the field of computer software. Examples of the computer readable media include magnetic media such as a hard disk, a floppy disk, and a magnetic tape, optical media such as a compact disc read only memory (CD-ROM) and a digital video disc (DVD), magneto-optical media such as a floptical disk, and a hardware device, such as a ROM, a random access memory (RAM), or a flash memory, that is specially made to store and perform the program instructions. Examples of the program instruction include machine code generated by a compiler and high-level language code that can be executed in a computer using an interpreter and the like. The hardware device may be configured as at least one software module in order to perform operations of embodiments of the present disclosure and vice versa.

While the present disclosure has been described with reference to specific details such as detailed components, specific embodiments and drawings, these are only exemplary to facilitate overall understanding of the present disclosure and the present disclosure is not limited thereto. It will be understood by those skilled in the art that various modifications and alterations may be made. Therefore, the spirit and scope of the present disclosure are defined not by the detailed description of the present disclosure but by the appended claims, and encompass all modifications and equivalents that fall within the scope of the appended claims.

What is claimed is:

1. A video encryption method comprising:
selecting one or more target frames to be encrypted from among frames of a target video;
detecting regions of interest in the target frames; and
performing encryption on the regions of interest.

2. The video encryption method of claim, 1, wherein, in the selecting of the target frames, the target frames are selected according to a frequency of references to the frames of the target video.

3. The video encryption method of claim, 1, wherein, in the selecting of the target frames, an I-frame, a P-frame, and a B-frame of at least one layer that is lower than a B-frame of a highest layer are selected as the target frames.

4. The video encryption method of claim, 1, wherein the performing of the encryption on the regions of interest includes:
identifying tiles including all or a part of the regions of interest in the target frames; and
performing encryption on the identified tiles.

5. The video encryption method of claim, 4, wherein, in the performing of the encryption on the regions of interest, some syntax elements among syntax elements generated prior to an entropy encoding stage are selectively encrypted in the entropy encoding stage.

6. The video encryption method of claim, 5, wherein, in the performing of the encryption on the regions of interest, some syntax elements among the syntax elements for the identified tiles are encrypted.

7. A video encryption method comprising:
receiving a target video;
selecting some frames from among all frames of the target video as target frames; and
encrypting the target frames.

8. The video encryption method of claim, 7, wherein, in the selecting of the some frames as the target frames, the target frames are selected according to a frequency of references to the frames of the target video.

9. The video encryption method of claim, 7, wherein, in the selecting of the some frames as the target frames, an I-frame, a P-frame, and a B-frame of at least one layer that is lower than a B-frame of a highest layer are selected as the target frames.

10. A video encryption device comprising:
a memory; and
at least one processor electrically connected to the memory,
wherein the processor selects one or more target frames to be encrypted from among frames of a target video, detects regions of interest in the target frame, and performs encryption on the regions of interest.

11. The video encryption device of claim, 10, wherein the processor selects the target frames according to a frequency of references to the frames of the target video.

12. The video encryption device of claim, 10, wherein the processor selects an I-frame, a P-frame, and a B-frame of a layer that is lower than a B-frame of a highest layer as the target frames.

13. The video encryption device of claim, 12, wherein a layer of the B-frame selected as the target frames is adaptively determined according to resource usage of the video encryption device.

14. The video encryption device of claim, 10, wherein the processor identifies tiles including all or a part of the regions of interest in the target frames, and performs encryption on the identified tiles.
